(19) United States
(12) Patent Application Publication
(10) Pub. No.: US 2024/0279816 A1
(43) Pub. Date: Aug. 22, 2024

(54) SILVER-CONTAINING FILM AND METHOD FOR PRODUCING SAME

(71) Applicant: Kabushiki Kaisha Kobe Seiko Sho (Kobe Steel, Ltd.), Kobe-shi (JP)

(72) Inventors: Sho KATSURA, Kobe-shi (JP); Shintaro YAMAMOTO, Kobe-shi (JP); Hirotaka ITO, Kobe-shi (JP); Takayuki KOYAMA, Kobe-shi (JP); Masahiro TSURU, Shimonoseki-shi (JP)

(73) Assignee: Kabushiki Kaisha Kobe Seiko Sho (Kobe Steel, Ltd.), Kobe-shi (JP)

(21) Appl. No.: 18/552,792

(22) PCT Filed: Feb. 24, 2022
(86) PCT No.: PCT/JP2022/007673

§ 371 Date: Apr. 15, 2024

(30) Foreign Application Priority Data
Mar. 30, 2021 (JP) 2021-057353

(51) Int. Cl. C23C 28/00

(52) U.S. Cl. CPC C23C 28/321

(57) ABSTRACT

A silver-containing film including a silver-containing layer containing silver in an amount of 50 mass % or more, and particles made of a non-conductive organic compound and being in contact with the silver-containing layer, wherein a carbon-containing reactive layer can be formed on the silver-containing layer.

### TECHNICAL FIELD

The present disclosure relates to a silver-containing film and a method for producing the same.

### BACKGROUND ART

With tightening of CO₂ emission regulations, the number of electric vehicles (EVs) and plug-in hybrid vehicles (PHEVs) that are less dependent on fossil fuels is expected to increase. Since these automobiles require charging of a battery on a daily basis, it is necessary to assume insertion and removal a significantly larger number of times for a material of a contact terminal for connecting an external power supply to an automobile than those used in conventional automobiles. In this field, silver (Ag) plating with high electrical conductivity (low contact resistance) is usually applied in many cases. The hardness of an Ag plating film is generally low, and “galling” tends to occur during sliding between Ag materials. Therefore, an Ag plating film has a problem that abrasion easily progresses when repeated insertion and removal (sliding) is performed.

It has long been aimed at improving abrasion resistance of an Ag plating film by increasing the hardness thereof, and the following methods, for example, have been studied:
(1) an increase in hardness of an Ag plating film by crystal grain refinement; and

(2) an increase in hardness by alloying Ag with selenium (Se), antimony (Sb), etc. . . .

However, neither of the methods (1) and (2) is sufficient to improve abrasion resistance. In addition, Se and Sb are toxic elements, and need to be handled carefully. There is also a problem that alloying with Se and Sb decreases electrical conductance.

Various improvements of abrasion resistance by ideas other than an increase in hardness of a plating film have also been studied. As disclosed in Non-patent Documents 1 and 2, the following method has been studied:
(3) improvement of abrasion resistance by codeposition (dispersion plating) of carbon-based particles into an Ag plating film.
   In this study, graphite, carbon black (CB), and carbon nanotubes (CNTs) have been mainly used. The reason for using them is considered to be that: (i) the carbon-based particles such as graphite act as a solid lubricant, and are therefore expected to have an effect of improving abrasion resistance; and (ii) the carbon-based particles have electrical conductivity, and therefore have no possibility of worsening contact resistance with a contact point when the carbon-based particles are codeposited (dispersed) in an Ag matrix. In fact, Non-patent Document 1 discloses that an Ag-graphite composite plating film obtained by suspending graphite particles in an Ag plating solution for a plating process can realize better abrasion resistance in comparison with not only an Ag plating film, but also a hard Ag—Sb alloy plating film.

### CONVENTIONAL ART DOCUMENTS

### Patent Documents

Non-patent Document 1: Materia Japan, Vol. 58, No. 1 (2019), pp. 41-43
Non-patent Document 2: Proceedings of the 81st Conference of The Surface Finishing Society of Japan, 27A-1

### DISCLOSURE OF THE INVENTION

### Problems to be Solved by the Invention

The method (3) has been studied for a very long time as in Non-patent Document 2, and can be said to be a very common method for improving abrasion resistance of a silver-containing film such as an Ag plating film. However, although the demand for a contact material having both abrasion resistance and electrical conductivity has increased with prediction of an increase in EVs and PHEVs, the utilization of the method (3) has not progressed. It can be considered that the reason for not progressing is due to a concern that when carbon particle dispersion plating is applied to an actual terminal material and sliding (insertion and removal) is repeated, the carbon particles held in the plating film fall off with the progress of abrasion of the contact portion. Since the carbon-based particles have good electrical conductivity, it can be considered that even if the carbon-based particles are codeposited in the silver-containing film, there is little possibility of inhibiting conduction at the contact portion. Meanwhile, when these particles fall off from the terminal surface and are piled up around the contact point, a short circuit at the contact point may be caused. In particular, there may be a serious concern about safety in the terminal portions for EVs and PHEVs that require conduction with high voltage and large current.

The present disclosure has been made in view of such a situation, and an object thereof is to provide a silver-containing film capable of sufficiently reducing a short circuit at a contact point due to falling off of conductive particles and having sufficient abrasion resistance and electrical conductivity, and a method for producing the same.

### Means for Solving the Problems

The present invention according to a first aspect provides
a silver-containing film including:
a silver-containing layer containing silver in an amount of 50 mass % or more, and
particles made of a non-conductive organic compound and being in contact with the silver-containing layer,
wherein a carbon-containing reactive layer can be formed on the silver-containing layer.

The present invention according to a second aspect provides
the silver-containing film according to the first aspect, wherein the non-conductive organic compound contains any one or more selected from a list consisting of a carbonyl group (—C(═O)—), an amino group (—NR¹R² wherein R¹ and R² are hydrogen or a hydrocarbon group, and R¹ and R² may be identical or different) and a hydroxy group (—OH), in a unit molecular structure.

The present invention according to a third aspect provides
the silver-containing film according to the first or second aspect, including the carbon-containing reactive layer on the silver-containing layer.

The present invention according to a fourth aspect provides
a method for producing the silver-containing film according to the third aspect, including a step of subjecting the silver-containing film according to the first or second aspect to a sliding process.

### Effects of the Invention

According to embodiments of the present invention, it is possible to provide a silver-containing film capable of sufficiently reducing a short circuit at a contact point due to falling off of conductive particles and having sufficient abrasion resistance and electrical conductivity, and a method for producing the same.

### BRIEF DESCRIPTION OF THE DRAWINGS

FIG. 1A is a schematic cross-sectional view of an example of a silver-containing film (before a sliding process) according to embodiments of the present invention.

FIG. 1B is a schematic cross-sectional view of an example of the silver-containing film (after the sliding process) according to the embodiments of the present invention.

FIG. 2A is a schematic cross-sectional view of another example of the silver-containing film (before the sliding process) according to the embodiment of the present invention.

FIG. 2B is a schematic cross-sectional view of another example of the silver-containing film (after the sliding process) according to the embodiments of the present invention.

FIG. 3A is a schematic cross-sectional view of another example of the silver-containing film (before the sliding process) according to the embodiments of the present invention.

FIG. 3B is a schematic cross-sectional view of another example of the silver-containing film (after the sliding process) according to the embodiments of the present invention.

FIG. 4 is a cross-sectional TEM image of a silver-containing film of No. 13 of Example 2 after abrasion resistance evaluation.

FIG. 5 shows a result of abrasion resistance evaluation of a silver-containing film of No. 1 of Example 1.

FIG. 6 shows a result of abrasion resistance evaluation of a silver-containing film of No. 2 of Example 1.

FIG. 7 shows a result of abrasion resistance evaluation of a silver-containing film of No. 3 of Example 1.

FIG. 8 shows a result of abrasion resistance evaluation of a silver-containing film of No. 4 of Example 1.

FIG. 9 shows a result of abrasion resistance evaluation of a silver-containing film of No. 5 of Example 1.

FIG. 10 shows a result of abrasion resistance evaluation of a silver-containing film of No. 6 of Example 1.

FIG. 11 shows a result of abrasion resistance evaluation of a silver-containing film of No. 7 of Example 1.

FIG. 12 shows a result of abrasion resistance evaluation of a silver-containing film of No. 8 of Example 1.

FIG. 13 shows a result of abrasion resistance evaluation of a silver-containing film of No. 9 of Example 1.

FIG. 14 shows a result of abrasion resistance evaluation of a silver-containing film of No. 10 of Example 1.

FIG. 15 shows a result of abrasion resistance evaluation of a silver-containing film of No. 11 of Example 1.

FIG. 16 shows a result of abrasion resistance evaluation of a silver-containing film of No. 12 of Example 1.

FIG. 17 shows a result of abrasion resistance evaluation of a silver-containing film of No. 13 of Example 2.

FIG. 18 shows a result of abrasion resistance evaluation of a silver-containing film of No. 14 of Example 2.

FIG. 19A is a STEM-HAADF image of a partial region of FIG. 4.

FIG. 19B shows an EDX analysis result at a point indicated by “1” in FIG. 19A.

FIG. 19C shows an EDX analysis result at a point indicated by “2” in FIG. 19A.

### MODE FOR CARRYING OUT THE INVENTION

The present inventors have studied from various angles in order to realize a silver-containing film capable of sufficiently reducing a short circuit at a contact point due to falling off of conductive particles and having sufficient abrasion resistance and electrical conductivity. In the study of the conventional codeposition plating technique as disclosed in Non-patent Document 1, carbon-based particles such as graphite have been mostly used as a solid lubricating material being cleavable (and one having good electrical conductivity). However, as a result of studies conducted by the present inventors, it was found that abrasion resistance is not improved sufficiently even when talc, which is inorganic particles having solid lubricating property, is contacted with the silver-containing layer. In contrast, it was also found that abrasion resistance is improved sufficiently by contacting (or supporting) non-conductive organic compound particles not necessarily having solid lubricating property with the silver-containing layer. It can be considered that a layer containing carbon (hereinafter, the layer is referred to as a “carbon-containing reactive layer”) having a component different from that of the silver-containing layer was formed on the silver-containing layer with which the non-conductive organic compound particles are contacted, and abrasion resistance was improved sufficiently by the carbon-containing reactive layer. Furthermore, the carbon-containing reactive layer is less likely to inhibit electrical conductivity. As a result, the possibility of a short circuit at the contact point due to falling off of the conductive particles has been able to be reduced sufficiently, and a silver-containing film having sufficient abrasion resistance and electrical conductivity has been able to be realized.

Hereinafter, details of requirements defined by the embodiments of the present invention will be described.

A silver-containing film according to embodiments of the present invention includes a silver-containing layer and particles made of a non-conductive organic compound and being in contact with the silver-containing layer. In the silver-containing film according to the embodiments of the present invention, the carbon-containing reactive layer can be formed on the silver-containing layer by subjecting the silver-containing film to a sliding process as described later. It can be considered that the carbon-containing reactive layer is formed on the silver-containing layer due to decomposition of a part of the organic compound through the sliding process. The carbon-containing reactive layer can reduce a friction coefficient and impart abrasion resistance without reducing the electrical conductivity of the silver-containing film.

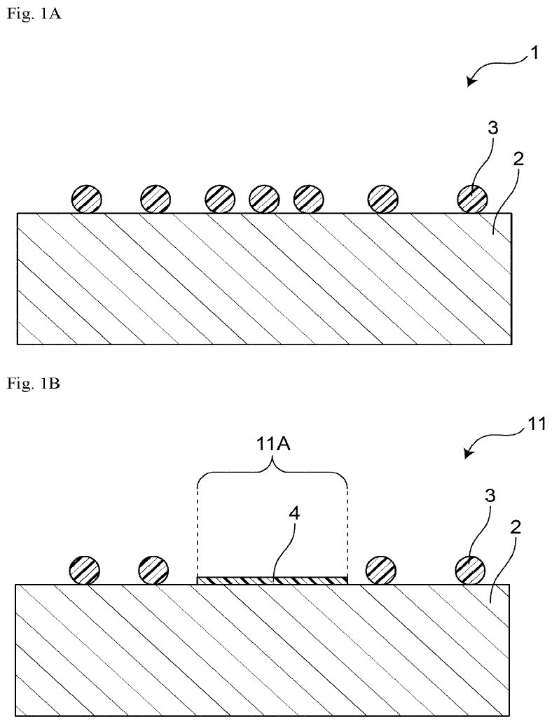

FIG. 1A shows a schematic cross-sectional view of an example of a silver-containing film according to embodiments of the present invention. In FIG. 1A, a silver-containing film 1 includes a silver-containing layer 2 and particles 3 made of a non-conductive organic compound (hereinafter, the particles are sometimes simply referred to as “particles 3”) and being in contact with (adhered to) the silver-containing layer 2.

Subjecting the silver-containing film 1 to a sliding process can form a carbon-containing reactive layer on the silver-containing layer 2 (due to decomposition of a part of the non-conductive organic compound of the particles 3). FIG. 1B shows a schematic cross-sectional view after subjecting the silver-containing film 1 to a sliding process. In a silver-containing film 11, a carbon-containing reactive layer 4 is formed on the silver-containing layer 2 in a slid portion 11A. As shown in FIG. 1B, in the slid portion 11A, the particles 3 can fall off by the sliding process, and thus, for example, when the silver-containing film 11 is used as a terminal contact material, the portion may be easily conducted. In addition, in FIG. 1B, an end of the slid portion 11A and an end of the carbon-containing reactive layer 4 are aligned with each other, but do not have to necessarily be aligned with each other.

On the silver-containing film according to the embodiments of the present invention, the carbon-containing reactive layer 4 can be formed. The phrase “the carbon-containing reactive layer 4 can be formed” is meant to include a state before the carbon-containing reactive layer 4 is formed as in the silver-containing film 1 (and silver-containing films 21 and 41 described later) and a state in which the carbon-containing reactive layer 4 is actually formed as in the silver-containing film 11 (and silver-containing films 31 and 51 described later).

The silver-containing layer 2 is a layer containing silver in an amount of 50 mass % or more. As the silver-containing layer 2, in addition to a soft Ag plating, a hard Ag plating, a glossy Ag plating, a semi-glossy Ag plating, and the like used for a normal terminal surface treatment, an alloy plating can also be used for the purpose of improving corrosion resistance (sulfurization resistance or the like) of a matrix, improving abrasion resistance, or the like. However, since abrasion resistance can be imparted by the carbon-containing reactive layer 4, when there is no other purpose such as improvement of corrosion resistance, it is preferable to use a pure Ag plating layer having excellent electrical conductivity as a support. For example, it is preferable that the silver-containing layer 2 contains silver in an amount of 90 mass % or more, more preferably 95 mass % or more, and still more preferably 99 mass % or more.

The silver content of the silver-containing layer 2 when the particles 3 made of a non-conductive organic compound are codeposited in the silver-containing layer 2 as described later can be determined by performing a chemical composition analysis of a portion excluding the particles 3 made of a non-conductive organic compound.

The thickness of the silver-containing layer 2 is not particularly limited. The thickness can be appropriately adjusted according to the application, but may be, for example, 100 μm or less, or 50 μm or less.

With respect to the particles 3 made of a non-conductive organic compound, the term “non-conductive” means that the organic compound does not exhibit electrical conductivity, and refers to, for example, particles exhibiting a volume resistivity of about 10³ [Ω·cm] or more as measured in accordance with ASTM D257.

With respect to the particles 3 made of a non-conductive organic compound, the “organic compound” refers to a compound containing carbon excluding compounds having a simple structure such as carbon monoxide, carbon dioxide, a carbonate, hydrocyanic acid, a cyanate, a thiocyanate, B₄C, and SiC. For example, a silicone resin having a siloxane bond (—Si—O—Si—) as a main chain and having an organic group in a side chain is included in the “organic compound” in this specification. Since the particles 3 are made of an organic compound, a part of the organic compound can be decomposed through a sliding process to form the carbon-containing reactive layer 4.

The non-conductive organic compound preferably contains any one or more selected from a list consisting of a carbonyl group (—C(—O)—), an amino group (—NR¹R² wherein R¹ and R² are hydrogen or a hydrocarbon group, and R¹ and R² may be identical or different), and a hydroxy group (—OH) in a unit molecular structure. By the incorporation of any of these predetermined functional groups, decomposition of the organic compound is promoted, and the carbon-containing reactive layer 4 can be easily formed. Here, the “unit molecular structure” means one repeating unit in the case of a macromolecule (polymer), and an individual molecule in the case of a non-polymer.

With respect to the particles 3 made of a non-conductive organic compound, the “particle” means a relatively small substance having an equivalent circle diameter of 50 μm or less, and the particle may have any shape.

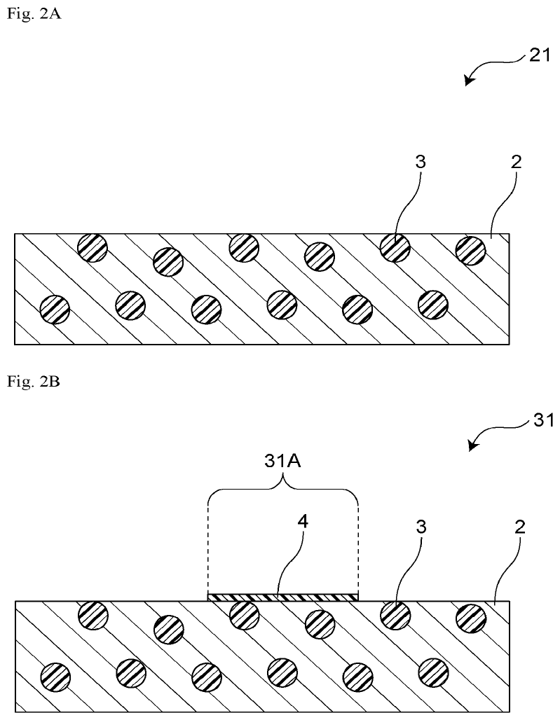

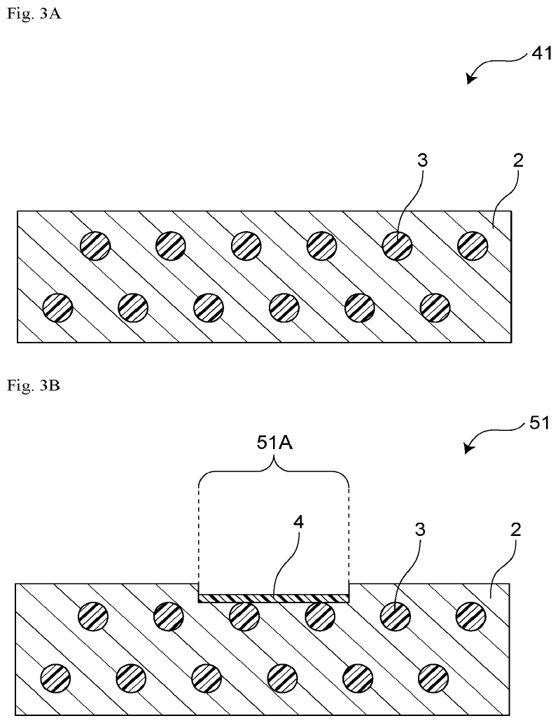

In the silver-containing film according to the embodiment of the present invention, the phrase “the particles are in contact” with the silver-containing layer 2 means that, for example, as shown in FIG. 1A, the particles 3 may be in contact with (adhered to) the surface of the silver-containing layer 2, and for example, the particles 3 may be codeposited (embedded) in the silver-containing layer 2. In that case, the particles 3 may be completely embedded in the silver-containing layer 2 as shown in FIG. 3A described later, or may be partially exposed on the surface of the silver-containing layer 2 as shown in FIG. 2A described later. From the viewpoint of easily forming the carbon-containing reactive layer 4, it is preferable that the particles 3 are partially exposed on the surface of the silver-containing layer 2. When the particles 3 are completely embedded in the silver-containing layer 2, the carbon-containing reactive layer 4 can be formed by subjecting the silver-containing film 1 to a sliding process so that the particles 3 are exposed.

FIG. 2A shows a schematic cross-sectional view of another example of the silver-containing film according to the embodiments of the present invention. In the silver-containing film 21, the particles 3 are embedded in the silver-containing layer 2 and partially exposed on the surface of the silver-containing layer 2. Subjecting the silver-containing film 21 to a sliding process can form a carbon-containing reactive layer on the silver-containing layer 2 (due to decomposition of a part of the non-conductive organic compound of the particles 3). FIG. 2B shows a schematic cross-sectional view after subjecting the silver-containing film 21 to a sliding process. In the silver-containing film 31, the carbon-containing reactive layer 4 is formed on the silver-containing layer 2 in a slid portion 31A. In addition, in FIG. 2B, an end of the slid portion 31A and an end of the carbon-containing reactive layer 4 are aligned with each other, but do not have to necessarily be aligned with each other.

FIG. 3A shows a schematic cross-sectional view of another example of the silver-containing film according to the embodiments of the present invention, and in a silver-containing film 41, the particles 3 are completely embedded in the silver-containing layer 2. Subjecting the silver-containing film 41 to a sliding process so that the particles 3 are exposed can form a carbon-containing reactive layer on the silver-containing layer 2 (due to decomposition of a part of the non-conductive organic compound of the particles 3). FIG. 3B shows a schematic cross-sectional view after subjecting the silver-containing film 41 to a sliding process. In the silver-containing film 51, the silver-containing layer 2 is slid so that the particles 3 are exposed in a slid portion 51A, and the carbon-containing reactive layer 4 is formed on the silver-containing layer 2. In FIG. 3B, an end of the slid portion 51A and an end of the carbon-containing reactive layer 4 are aligned with each other, but do not have to necessarily be aligned with each other.

Whether or not “the particles are in contact” with the silver-containing layer 2 can be determined, for example, by observing a cross section of the silver-containing film 1 (11, 21, 31, 41, or 51). Whether or not “the particles are in contact” with the silver-containing layer 2 can be determined by observing a cross section at a portion other than the slid portion 11A (31A or 51A) since the particles 3 may have fallen off in the slid portion 11A (31A or 51A) of the silver-containing film 11 (31 or 51).

In the silver-containing film according to the embodiments of the present invention, it is necessary that “the particles are in contact” with the silver-containing layer 2, but even in an aspect in which “a film is in contact” with the silver-containing layer 2, wherein the film is made of a non-conductive organic compound, the carbon-containing reactive layer 4 can be formed on the silver-containing layer 2. However, in the aspect in which “the film is in contact” with the silver-containing layer 2, the surface of the silver-containing layer 2 is coated with the film, and the initial contact resistance of the silver-containing film may be worsened. Therefore, the aspect in which “the particles are in contact” with the silver-containing layer 2 as in the embodiments of the present invention is preferable.

The optimum state of the size and the contact form of the particles 3 varies depending on the type of organic compound to be used and characteristics to be required. In any case, it is desirable that the particles 3 are in a state where it is more difficult to inhibit conduction between terminal contacts by the particles 3 when the particles 3 are contacted with the silver-containing layer 2. For example, in an aspect in which the particles 3 are codeposited (incorporated) in the silver-containing layer 2, it is desirable that the particles 3 have such a size that the particles can be completely embedded in the silver-containing layer 2. That is, the average particle diameter (equivalent circle diameter) of the particles 3 is preferably less than the thickness of the silver-containing layer 2.

In the silver-containing film 1 (11, 21, 31, 41, or 51) according to the embodiments of the present invention, from the viewpoint of exhibiting an effect of improving the abrasion resistance and maintaining the abrasion resistance for a long period of time, it is desirable that the number of particles to be contacted with the silver-containing layer 2 is larger. Meanwhile, when the particles present on the surface of the silver-containing layer 2 are not removed during the sliding process, conduction between terminal contacts is easily inhibited. Therefore, good electrical conductivity can be exhibited by controlling the exposure rate (particle coverage) of the surface of the silver-containing layer 2 when the silver-containing layer 2 is observed from above in FIGS. 1A and 1B (FIGS. 2A and 2B, and FIGS. 3A and 3B) within a given range. The exposure rate of the silver-containing layer 2 varies depending on the particle diameter and/or hardness of the particles to be used, but it is desirable that about 50 area % or more of the surface of the silver-containing layer 2 is exposed.

In the silver-containing film 1 (11, 21, 31, 41, or 51) according to the embodiments of the present invention, conductive particles may be in contact with the silver-containing film 1 in some cases. However, the smaller the number of conductive particles is, the more preferable it is because a short circuit at a contact point due to falling off of the conductive particles can be reduced. Therefore, 50 vol % or more of the particles in contact with the silver-containing film 1 (11, 21, 31, 41, or 51) according to the embodiments of the present invention are preferably the particles 3 made of a non-conductive organic compound. It is more preferable that 60 vol % or more, 70 vol % or more, 80 vol % or more, and 90 vol % or more of the particles are the particles 3 made of a non-conductive organic compound. It is still more preferable that all (100 vol %) of the particles are the particles 3 made of a non-conductive organic compound. In addition, the silver-containing film 1 (11, 21, 31, 41, or 51) according to the embodiments of the present invention may be in contact with inorganic particles in some cases.

In the silver-containing film according to the embodiments of the present invention, the carbon-containing reactive layer 4 can be formed on the silver-containing layer 2. The phrase “the carbon-containing reactive layer 4 can be formed” is meant to include a state before the carbon-containing reactive layer 4 is formed as in the silver-containing film 1 (21 or 41) (that is, before the sliding process) and a state in which the carbon-containing reactive layer 4 is actually formed as in the silver-containing film 11 (31 or 51) (that is, after the sliding process). Whether or not “the carbon-containing reactive layer 4 can be formed” in the silver-containing film 1 (21 or 41) can be determined by, for example, subjecting the silver-containing film 1 (21 or 41) to a sliding process under the following condition A (as to the silver-containing film 41, it is subjected to the sliding process so that the particles 3 are exposed, and then, further subjected to the sliding process under the following condition A), then performing cross-sectional TEM observation (and an EDX analysis), and examining the presence or absence of the carbon-containing reactive layer 4 as shown in FIG. 1B (FIG. 2B or 3B). Whether or not “the carbon-containing reactive layer 4 can be formed” in the silver-containing film 11 (31 or 51) can be determined by performing cross-sectional TEM observation (and a composition analysis) and examining the presence or absence of the carbon-containing reactive layer 4 as shown in FIG. 1B (FIG. 2B or 3B). After the following sliding process condition A, the silver-containing film can be abraded by about 5 μm or more although there is a difference depending on the hardness of the silver-containing film. Therefore, for example, also when the sliding process is performed such that the particles 3 are exposed, the particles 3 can be easily exposed by appropriately controlling the number of cycles or the like of the following sliding process condition A.

### <Sliding Process Condition A>

A sample including a material obtained by forming an embossed shape of R=1.8 mm by hand pressing as a substrate, and a hard Ag plating layer (Vickers hardness HV: 160 or more) of 40 μm or more formed on the substrate is used as a counterpart material for sliding. The silver-containing film 1 as a target is subjected to a frictional sliding test (horizontal load tester manufactured by Aikoh Engineering Co., Ltd., applied vertical load: 3 N, sliding distance: 10 mm, sliding speed: 80 mm/min) of 500 cycles with the counterpart material.

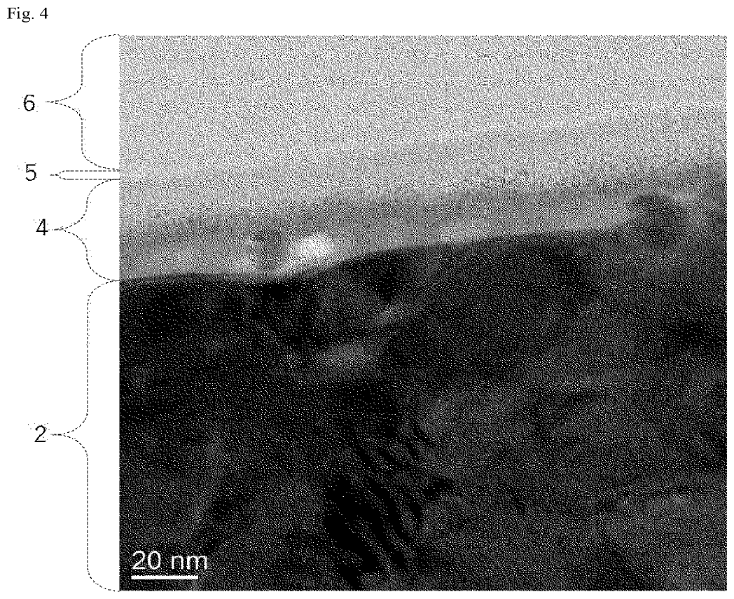

As an example, FIG. 4 shows a cross-sectional TEM image of the silver-containing film after subjecting the silver-containing film containing the particles 3 made of a non-conductive organic compound (melamine cyanurate) in contact with the silver-containing layer 2 to a sliding process. As shown in FIG. 4, the carbon-containing reactive layer 4 is formed on the silver-containing layer 2. An Os protective film 5 and a C protective film 6 are deposited on the carbon-containing reactive layer 4 for TEM observation. When the carbon-containing reactive layer 4 is subjected to a chemical composition analysis (for example, EDX or EELS analysis), carbon is detected. Note that, for example, at the time of an EDX or EELS analysis, it is necessary to narrow the beam diameter (for example, to about 1 nm) and perform measurement so as not to pick up a signal from another layer or the like as in the section of EXAMPLES described later. The carbon content of the carbon-containing reactive layer 4 may be, for example, 50 atom % or more.

The carbon-containing reactive layer 4 may contain silver in addition to carbon. This may be due to a reaction between the non-conductive organic compound and the silver-containing layer 2 and/or diffusion of silver atoms from the silver-containing layer 2. Further, the carbon-containing reactive layer 4 may contain an element derived from the non-conductive organic compound. For example, if the non-conductive organic compound contains an oxygen atom and/or a nitrogen atom, the carbon-containing reactive layer 4 may also contain an oxygen atom and/or a nitrogen atom. Whether or not these atoms are contained can be investigated by performing an EDX analysis. Further, the carbon-containing reactive layer 4 may contain amorphous carbon. Whether or not amorphous carbon is contained can be investigated by performing a Raman analysis.

The thickness of the carbon-containing reactive layer 4 is preferably 200 nm or less, more preferably 100 nm or less. This makes it difficult to lower the electrical conductivity of the silver-containing film 11 (31 or 51). On the other hand, the thickness of the carbon-containing reactive layer 4 is preferably 1 nm or more, more preferably 2 nm or more. This can further improve the abrasion resistance.

The silver-containing film 1 (11, 21, 31, 41, or 51) according to the embodiment of the present invention may include another layer (for example, a substrate layer or a strike plating layer) for achieving the object of the present disclosure.

The silver-containing film 1 according to the embodiments of the present invention can be produced by, for example, subjecting a substrate such as a copper plate to a silver plating process by applying electricity to a silver (or silver alloy) plating solution under general conditions to form the silver-containing layer 2, and then applying a dispersion of the particles 3 made of a non-conductive organic compound to the surface. This provides the silver-containing film 1 in which the particles 3 made of a non-conductive organic compound are in contact with the surface of the silver-containing layer 2. Further, subjecting the silver-containing film 1 to a sliding process under the above-mentioned sliding process condition A can produce the silver-containing film 11 in which the carbon-containing reactive layer 4 is formed on the silver-containing layer 2. In some cases, the silver-containing film 1 may be subjected to a strike silver plating process before the silver plating process.

Alternatively, the particles 3 made of a non-conductive organic compound are dispersed in a silver (or silver alloy) plating solution, and it is subjected to an electroplating process under stirring to obtain a silver-containing film in which the particles 3 made of a non-conductive organic compound are codeposited in the silver-containing layer 2 (the silver-containing film 21 in which the particles 3 are partially exposed on the surface of the silver-containing layer 2 or the silver-containing film 41 in which the particles 3 are completely embedded in the silver-containing layer 2). In the silver-containing film 21, the carbon-containing reactive layer 4 can be formed on the silver-containing layer 2 by subjecting the silver-containing film 21 to the sliding process under the sliding process condition A. In the silver-containing film 41, the carbon-containing reactive layer 4 can be formed on the silver-containing layer 2 by subjecting the silver-containing film 41 to the sliding process so that the particles 3 are exposed and then further subjecting the silver-containing film 41 to the sliding process under the sliding process condition A.

In the process in which the particles 3 are dispersed in a plating solution and electroplating is performed to codeposit the particles 3 in the silver-containing film, the following reactions (1) and (2) proceed simultaneously.

(1) a reaction in which particles dispersed in a liquid are electrostatically or physically adsorbed to (contacted with) the surface of the substrate

(2) a reaction in which the silver-containing layer 2 is deposited (grown) on the surface of the substrate

The particles 3 adsorbed in the reaction (1) are incorporated into the silver-containing layer 2 in the reaction (2), whereby “codeposition” takes place. Under the condition that the codeposition plating proceeds steadily, the particles 3 adsorbed at the initial stage of the reaction are incorporated into the silver-containing layer 2, and at the same time, adsorption of new particles 3 takes place. Therefore, even when the plating process is stopped, the particles 3 are exposed on the outermost surface in many cases, and the silver-containing film 21 in which the particles 3 are partially exposed on the surface of the silver-containing layer 2 can be easily produced in a common codeposition plating process.

Here, since the codeposition amount of the particles 3 into the silver-containing layer 2 is determined by the balance between the adsorption frequency in the reaction (1) and the plating film growth rate in the reaction (2), the codeposition amount can be changed by changing the plating conditions (and plating bath conditions). For example, it is possible to produce the silver-containing film 41 in which the particles 3 are completely embedded in the silver-containing layer 2 by providing a layer in which the particles 3 are not codeposited on the outermost surface side of the plating. This is achieved by the following means, for example: at the end of the plating process, to perform the process using a plating solution not containing the particles 3 dispersed in the plating solution, or to change the stirring speed of the plating solution to reduce the adsorption frequency in the reaction (1).

For example, subjecting the silver-containing film 1 (21 or 41) according to the embodiments of the present invention to the sliding process under the sliding process condition A (in the case of the silver-containing film 41, performing the sliding process under the sliding process condition A after exposing the particles 3) can provide the silver-containing film 11 (31 or 51) in which the carbon-containing reactive layer 4 is formed on the silver-containing layer 2 so as to not only have sufficient electrical conductivity but also have sufficient abrasion resistance. Specifically, the contact resistance after 500 cycles under the sliding process condition A is 0.50 [mΩ] or less, and the friction coefficient (ratio of horizontal load to vertical load) is 0.30 or less.

In the silver-containing film 1 (21 or 41) according to the embodiments of the present invention, from the viewpoint of handleability as a contact terminal material, an aspect in which the carbon-containing reactive layer 4 is easily formed and the friction coefficient is reduced is preferable. Specifically, the friction coefficient after 100 cycles under the sliding process condition A is preferably 0.30 or less.

### EXAMPLES

The embodiments of the present invention will be described in more detail by way of Examples. It is to be understood that the embodiments of the present invention are not limited to the following Examples, and various design variations made in accordance with the purports mentioned hereinbefore and hereinafter are also included in the scope of the embodiments of the present invention.

### Example 1

The surface of a pure copper plate having a thickness of 0.3 mm as a plating substrate was degreased by acetone cleaning. Then, a strike Ag plating process was performed to a thickness of about 0.1 μm as a base by using a commercially available strike Ag plating solution (Dyne Silver GPE-ST manufactured by Daiwa Fine Chemicals Co., Ltd.) and a pure Ag plate as a counter electrode, and applying electricity at a current density of 5 A/dm² for 1 minute for a plating process. The resultant was used as a substrate. Thereafter, a semi-glossy Ag plating layer (silver content: 99 mass % or more) having a thickness of about 10 μm was formed by applying electricity at a current density of 3 A/dm² for 5 minutes using a commercially available non-cyanide semi-glossy Ag plating solution (Dyne Silver GPE-SB manufactured by Daiwa Fine Chemicals Co., Ltd.) and using a pure Ag plate as a counter electrode. Thereafter, the following silver-containing films of No. 1 to No. 12 in which various particles were in contact with the surface of the Ag plating layer were produced by putting drops of liquid, which is obtained by suspending various particles (or a dispersion of particles) shown in Table 1 in an alcohol at a ratio of 20 mg/ml, on the surface of the Ag plating layer at 0.2 ml/cm², followed by drying.

TABLE 1

| | | | Average |
|---|---|---|---|
| | | | particle |
| | | | diameter |
| No. | Particle type | Manufacturer, etc. | (μm) |
| 1 | Melamine cyanurate | Melamine cyanurate dispersion | <2 |
| | | manufactured by | |
| | | Nissan Chemical Corporation | |
| 2 | Nylon 12 | Nylon 12 powder manufactured by | 5 |
| | | Toray Industries, Inc. | |
| 3 | Ethylene-acrylic acid | FLO-BEADS manufactured by | 10 |
| | copolymer | Sumitomo Seika Chemicals Co., Ltd. | |
| 4 | Polyethylene oxide | Polyethylene oxide powder | 6 |
| | | manufactured by Honeywell | |
| 5 | PTFE | PTFE powder manufactured by Seishin | 3 |
| | | Enterprise Co., Ltd. | |
| 6 | Polypropylene | Polypropylene powder manufactured by | 5 |
| | | Seishin Enterprise Co., Ltd. | |
| 7 | Paraffin | Hydrocarbon wax powder | <0.3 |
| | | manufactured by SASOL Ltd. | |
| 8 | Graphite | Graphite powder manufactured by | 5 |
| | | Kojundo Chemical Lab. Co., Ltd. | |
| 9 | SiC | SiC powder manufactured by Kojundo | <3 |
| | | Chemical Lab. Co., Ltd. | |
| 10 | Talc | Talc powder manufactured by Wako | — |
| | | Pure Chemical Industries, Ltd. | |
| 11 | B₄C | Boron carbide powder manufactured by | 0.5 |
| | | Kojundo Chemical Lab. Co., Ltd. | |
| 12 | (No particles) | — | — |

The silver-containing films of No. 1 to No. 12 were evaluated for abrasion resistance and contact resistance.

### <Abrasion Resistance Evaluation>

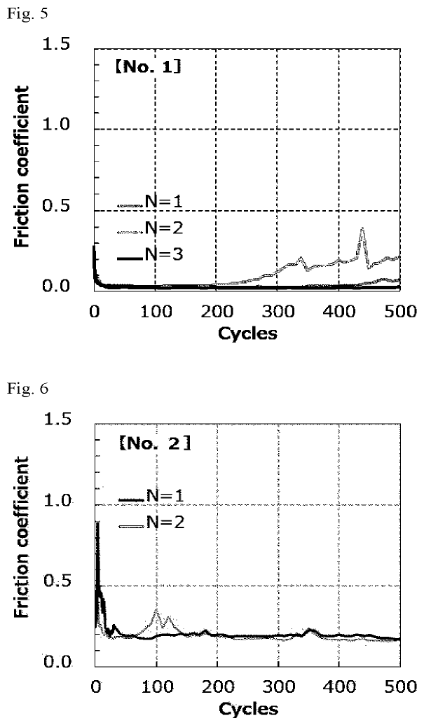

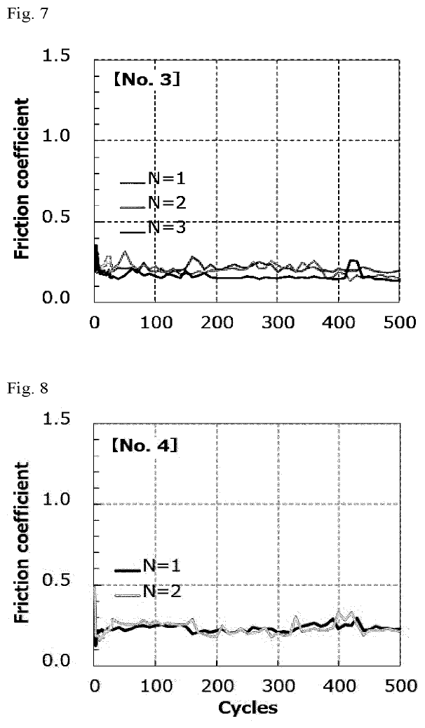

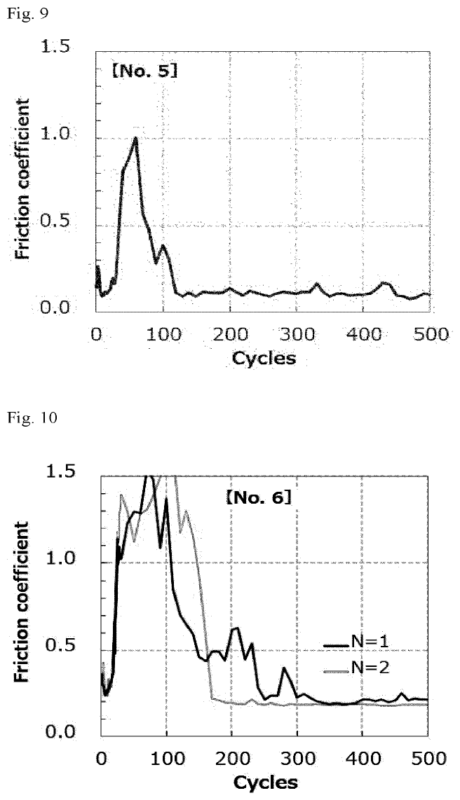

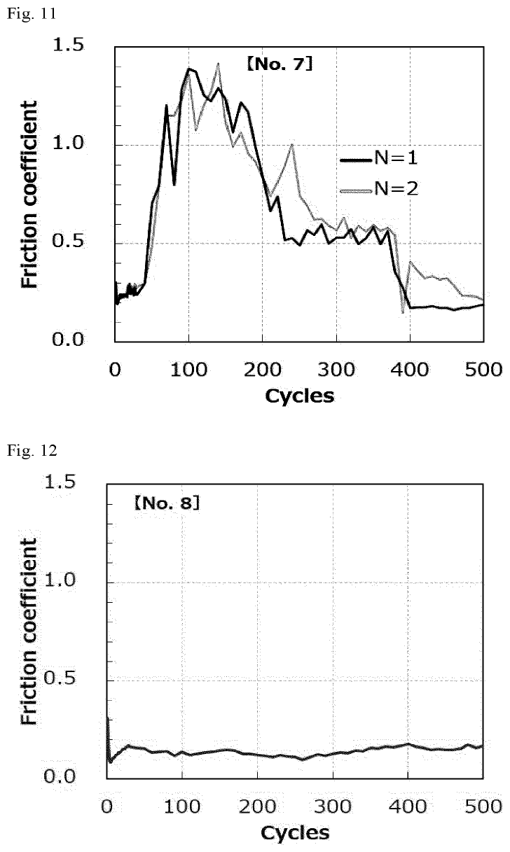

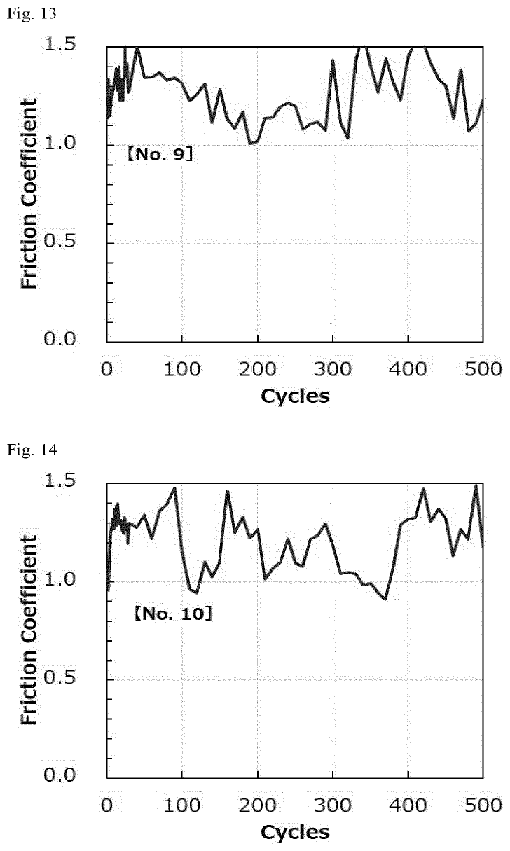

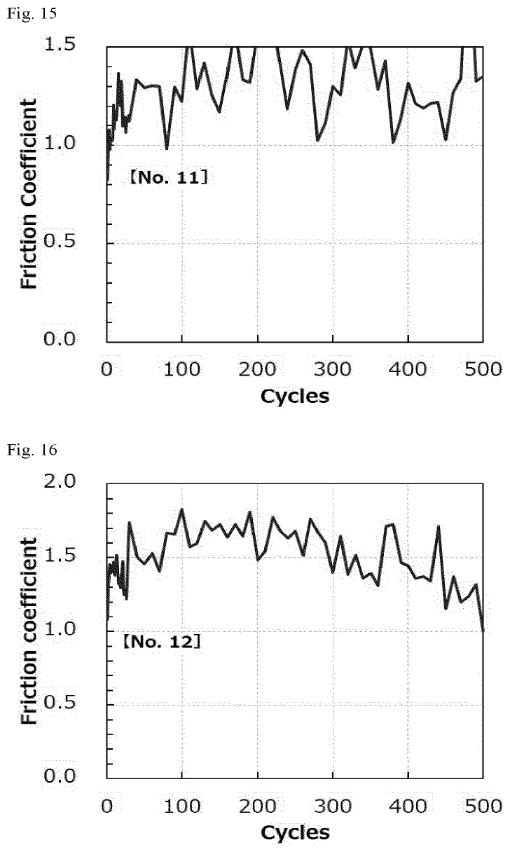

A sample obtained by forming a hard Ag plating (Vickers hardness Hv: about 165) layer of about 50 μm on a pure copper plate having a thickness of 0.25 mm with an embossed shape of R=1.8 mm formed by hand pressing was used as a counterpart material, and a frictional sliding test of up to 500 cycles was performed on No. 1 to No. 12 (using a horizontal load tester manufactured by Aikoh Engineering Co., Ltd., applied vertical load: 3 N, sliding distance: 10 mm, sliding speed: 80 mm/min) with the counterpart material. The results are shown in FIGS. 5 to 16. FIGS. 5 to 16 show the results of the frictional sliding test performed on the silver-containing films of Test Nos. 1 to 12, respectively, where the horizontal axis represents the number of cycles and the vertical axis represents the friction coefficient.

The maximum value of the friction coefficient (ratio of horizontal load to vertical load) in each sliding cycle was measured, and one having a friction coefficient of 0.30 or less after 500 cycles was determined to have sufficient abrasion resistance, which was evaluated as “B”. In addition, one having a friction coefficient of 0.30 or less after 100 cycles was determined to be “A” as a preferable aspect. For those measured a plurality of times, determination was made based on the average value of the measurements.

### <Contact Resistance Evaluation>

As for an abrasion mark (slid portion) after the abrasion resistance evaluation, a contact resistance at a contact point was measured using an electrical contact simulator (manufactured by Yamasaki-Seiki Kenkyusho, Inc.). The applied load was set to 5 N, and the average value of measurements at three points was used as the contact resistance for determination. When the contact resistance after the friction test was 0.50 [mΩ] or less, the silver-containing film was determined to have sufficient electrical conductivity, which was evaluated as “B”. (contact resistance measurement was omitted when abrasion resistance was insufficient).

The above results are summarized in Table 2. In the column of “Short circuit prevention”, when 50 vol % or more of the particles in contact with the silver-containing layer were non-conductive particles, it was determined that a short circuit at the contact point due to falling off of the particles can be sufficiently reduced, which was evaluated as “B”. When less than 50 vol % of the particles in contact with the silver-containing layer were non-conductive particles (that is, when more than 50 vol % of the particles in contact with the silver-containing layer were conductive particles), it was determined that there is a possibility of a short circuit at the contact point due to falling off of the particles, which was evaluated as “C”. In the column of “Comprehensive evaluation”, “B” was written in the case where the silver-containing film was determined as “B” in all the columns of “Short circuit prevention”, “Abrasion resistance”, and “Electrical conductivity”, “A” was written in the case where the silver-containing film was additionally determined as “A” in the column of “Abrasion resistance”, and “C” was written in the case where the silver-containing film was determined as “C” in at least one of the columns of “Short circuit prevention”, “Abrasion resistance”, and “Electrical conductivity”.

TABLE 2

| | Particle properties | | | | |
|---|---|---|---|---|---|
| | | | | Carbonyl | Characteristics of silver- |
| | | | | group, amino | containing film |
| | | | | group, or | Short |
| | | Non- | Organic | hydroxy group | circuit |
| No. | Particle type | conductive? | compound? | is contained? | prevention |
| 1 | Melamine cyanurate | Yes | Yes | Yes | B |
| 2 | Nylon 12 | Yes | Yes | Yes | B |
| 3 | Ethylene-acrylic acid copolymer | Yes | Yes | Yes | B |
| 4 | Polyethylene oxide | Yes | Yes | Yes | B |
| 5 | PTFE | Yes | Yes | No | B |
| 6 | Polypropylene | Yes | Yes | No | B |
| 7 | Paraffin | Yes | Yes | No | B |
| 8 | Graphite | No | No | No | C |
| 9 | SiC | Yes | No | No | B |
| 10 | Talc | Yes | No | No | B |
| 11 | B₄C | Yes | No | No | B |
| 12 | (No particles) | — | — | — | B |

| | Characteristics of silver-containing film | | | | | |
|---|---|---|---|---|---|---|
| | Abrasion resistance | | | | | |
| | Friction | Friction | | Electrical conductivity | | |
| | coefficient | coefficient | | Contact | | |
| | (after 500 | (after 100 | | resistance | | Comprehensive |
| No. | cycles) | cycles) | Evaluation | [mΩ] | Evaluation | evaluation |
| 1 | 0.10 | 0.02 | A | 0.27 | B | A |
| 2 | 0.17 | 0.25 | A | 0.37 | B | A |
| 3 | 0.14 | 0.19 | A | 0.37 | B | A |
| 4 | 0.21 | 0.25 | A | 0.20 | B | A |
| 5 | 0.10 | 0.39 | B | 0.21 | B | B |
| 6 | 0.20 | >1.0 | B | 0.20 | B | B |
| 7 | 0.20 | >1.0 | B | 0.23 | B | B |
| 8 | 0.17 | 0.14 | A | 0.40 | B | C |
| 9 | >1.0 | >1.0 | C | — | — | C |
| 10 | >1.0 | >1.0 | C | — | — | C |
| 11 | >1.0 | >1.0 | C | — | — | C |
| 12 | >1.0 | >1.0 | C | — | — | C |

The results of Table 2 can be considered as follows. The silver-containing films of Nos. 1 to 7 in Table 2 all satisfied the requirements specified in the embodiments of the present invention, and could sufficiently reduce a short circuit at the contact point due to falling off of the conductive particles, and had sufficient abrasion resistance and sufficient electrical conductivity. Among them, the silver-containing films of Nos. 1 to 4 satisfied the preferable requirement that the non-conductive organic compound contains any one or more selected from a list consisting of a carbonyl group (—C(═O)—), an amino group (—NR¹R²) and a hydroxy group (—OH), in the unit molecular structure, and thus, showed a preferable result of the friction coefficient after 100 cycles being 0.30 or less.

A phenomenon in which the friction coefficient temporarily increased to 1.0 or more and then decreased was observed between 0 and about 120 cycles in the silver-containing film of No. 5, between 0 and about 250 cycles in the silver-containing film of No. 6, and between 0 and about 400 cycles in the silver-containing film of No. 7, respectively. This can be considered to probably indicate that the silver-containing film has a given abrasion resistance in the course of removal of the particles by the sliding process and that a carbon-containing reactive layer has not yet been formed between these cycles. Meanwhile, in the silver-containing films of Nos. 1 to 4, such a phenomenon was not observed (or the increase in friction coefficient was small). It can be considered that this is because the carbon-containing reactive layer was formed in fewer cycles as compared with the silver-containing films of Nos. 5 to 7.

In contrast, the silver-containing films of Nos. 8 to 12 in Table 2 did not satisfy the requirements specified in the embodiment of the present invention, and there was a possibility of a short circuit at the contact point due to falling off of the conductive particles, or the abrasion resistance was insufficient.

In the silver-containing film of No. 8, the friction coefficient was low probably owing to the solid lubricating property of graphite particles. However, since all particles were graphite particles and had electrical conductivity, there was a possibility of a short circuit at the contact point due to falling off of the conductive particles.

In the silver-containing films of Nos. 9 to 11, non-conductive inorganic particles were used, and abrasion resistance was insufficient. It can be considered that this is because a carbon-containing reactive layer was not formed unlike the silver-containing films of Nos. 1 to 7.

In the silver-containing film of No. 12, particles were not applied, and abrasion resistance was insufficient. It can be considered that this is due to the occurrence of galling between the silver-containing film and the mating material.

### Example 2

The surface of a pure copper plate having a thickness of 0.3 mm as a plating substrate was degreased by acetone cleaning. Then, a strike Ag plating process was performed to a thickness of about 0.1 μm as a base by using a commercially available strike Ag plating solution (Dyne Silver GPE-ST manufactured by Daiwa Fine Chemicals Co., Ltd.) and a pure Ag plate as a counter electrode, and applying electricity at a current density of 5 A/dm² for 1 minute for a plating process. The resultant was used as a substrate. Thereafter, various particles and a surfactant in predetermined amounts were dispersed in a commercially available non-cyanide semi-glossy Ag plating solution (Dyne Silver GPE-SB manufactured by Daiwa Fine Chemicals Co., Ltd.), and silver-containing films of No. 13 and No. 14 in which particles were codeposited (embedded) in an Ag plating layer (silver content: 99 mass % or more) having a thickness of about 10 μm were obtained by applying electricity at a current density of 3 A/dm² for 5 minutes using a pure Ag plate as a counter electrode under stirring. As for No. 13, the same particles made of melamine cyanurate as in No. 1 of Example 1 were used, and the dispersion amount in the liquid was set to 30 g/L. In addition, as for No. 13, sodium naphthalene sulfonate was used as the surfactant, and carboxymethyl cellulose (CMC) was used as a dispersant (stabilizer). As for No. 14, the same particles made of nylon 12 as in No. 2 of Example 1 were used, and the dispersion amount in the liquid was set to 70 g/L. In addition, as for No. 14, Surflon S231 (manufactured by AGX Seimi Chemical Co., Ltd.) was used as the surfactant, and the addition amount was set to 50 g/L.

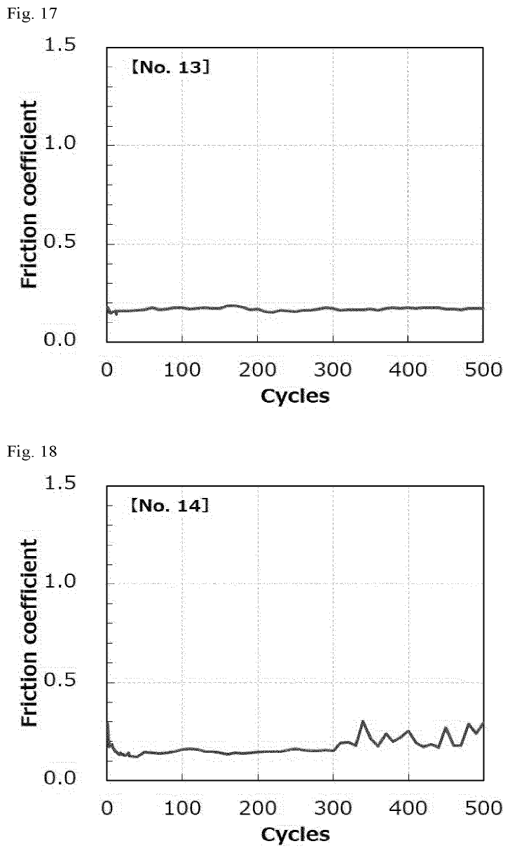

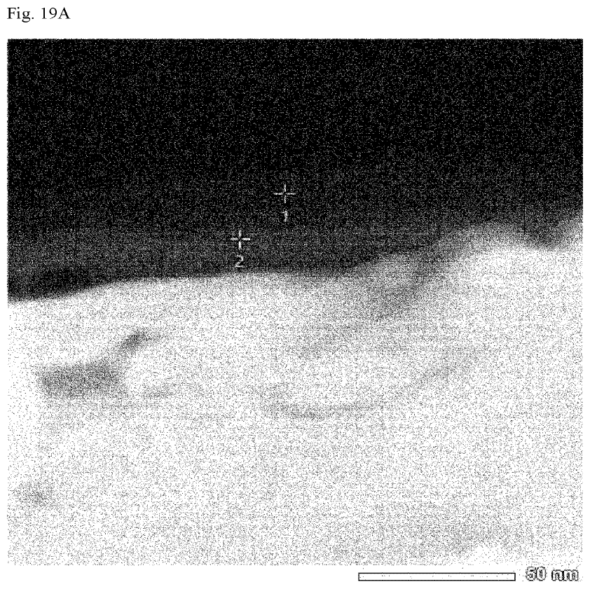

The silver-containing films of No. 13 and No. 14 were evaluated for abrasion resistance and contact resistance in the same manner as in Example 1. The evaluation results of abrasion resistance are shown in FIG. 17 (No. 13) and FIG. 18 (No. 14), and the results are summarized in Table 3.

TABLE 3

| | Particle properties | | | | |
|---|---|---|---|---|---|
| | | | | Carbonyl | Characteristics of silver- |
| | | | | group, amino | containing film |
| | | | | group, or | Short |
| | | Non- | Organic | hydroxy group | circuit |
| No. | Particle type | conductive? | compound? | is contained? | prevention |
| 13 | Melamine cyanurate | Yes | Yes | Yes | B |
| 14 | Nylon 12 | Yes | Yes | Yes | B |

| | Characteristics of silver-containing film | | | | | |
|---|---|---|---|---|---|---|
| | Abrasion resistance | | | | | |
| | Friction | Friction | | Electrical conductivity | | |
| | coefficient | coefficient | | Contact | | |
| | (after 500 | (after 100 | | resistance | | Comprehensive |
| No. | cycles) | cycles) | Evaluation | [mΩ] | Evaluation | evaluation |
| 13 | 0.17 | 0.18 | A | 0.20 | B | A |
| 14 | 0.30 | 0.16 | A | 0.10 | B | A |

The results of Table 3 can be considered as follows. The silver-containing films of Nos. 13 and 14 in Table 3 both satisfied the requirements specified in the embodiments of the present invention, and could sufficiently reduce a short circuit at the contact point due to falling off of the conductive particles, and had sufficient abrasion resistance and sufficient electrical conductivity. Further, the silver-containing films of Nos. 13 and 14 showed a preferable result of a friction coefficient being 0.30 or less after 100 cycles. It can be considered that this is because the particles made of a non-conductive organic compound were partially exposed on the surface of the silver plating layer before the sliding process and the non-conductive organic compound satisfied the preferable requirement of containing any one or more selected from a list consisting of a carbonyl group (—C(═O)—), an amino group (—NR¹R²) and a hydroxy group (—OH), in the unit molecular structure.

As for the silver-containing films (Nos. 1 to 7, 13, and 14) according to the embodiments of the present invention, after the abrasion resistance evaluation was performed, formation of the carbon-containing reactive layer was investigated. As an example, a cross-sectional TEM image of No. 13 is shown in FIG. 4. FIG. 4 is a cross-sectional TEM image of the slid portion after the abrasion resistance evaluation was performed on the silver-containing film of No. 13. A sample for a cross-sectional TEM image was prepared by FIB processing under the following conditions.

Fabrication apparatus: Focused ion beam processing observation apparatus FB-2000A manufactured by Hitachi, Ltd.
:Dual Beam (FIB/SEM) system Nova 200 manufactured by FEI Company Japan Ltd.
Acceleration voltage: 30 kV (picking-up), 5 kV (finishing)
Ion source: Ga

As a TEM observation apparatus, a field emission transmission electron microscope JEM-2100F manufactured by JEOL Ltd. was used.

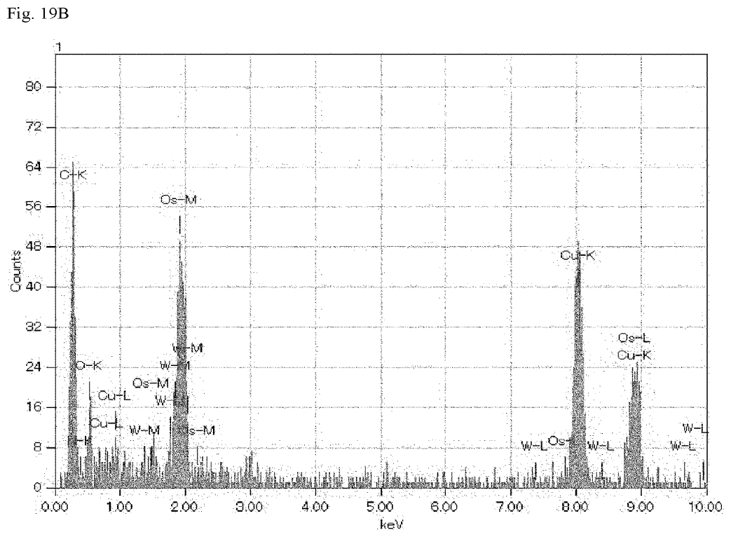

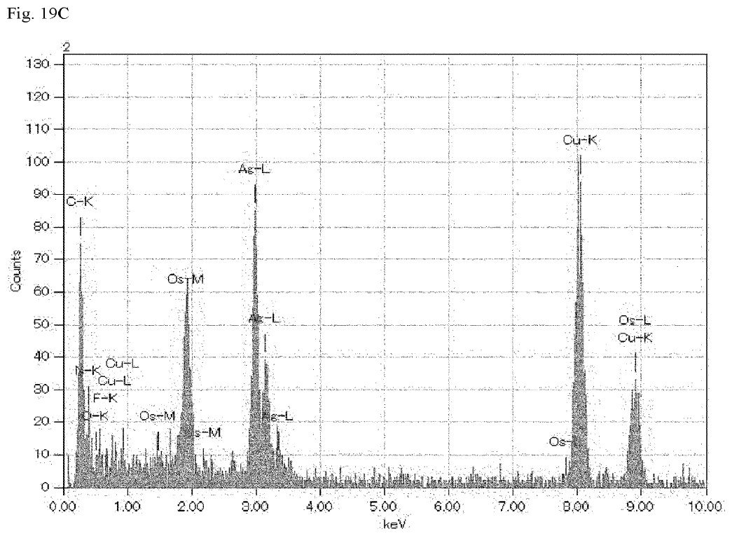

As shown in FIG. 4, the carbon-containing reactive layer 4 was formed on the silver-containing layer 2. The Os protective film 5 and the C protective film 6 were deposited on the carbon-containing reactive layer 4 for TEM observation. FIG. 19A shows a STEM-HAADF image of a partial region of FIG. 4, FIG. 19B shows EDX analysis results at the point indicated by “1” in FIG. 19A (an upper portion of the carbon-containing reactive layer 4), and FIG. 19C shows EDX analysis results at the point indicated by “2” in FIG. 19A (a lower portion of the carbon-containing reactive layer 4). As a TEM observation apparatus, a field emission transmission electron microscope JEM-2100F manufactured by JEOL Ltd. was used. As an EDX analyzer, JED-2300T SSD (attached to JEM-2100F) manufactured by JEOL Ltd. was used. The acceleration voltage was set to 200 kV, and the beam diameter was set to about 1 nm. The peak of Cu seen in the spectra of FIGS. 19B and 19C was a system noise due to a mesh for holding the sample. A large amount of carbon was detected and silver was also detected at both points “1” and “2” in FIG. 19A. However, a larger amount of silver was detected at the point indicated by “2” (the lower part of the carbon-containing reactive layer 4) than at the point indicated by “1”.

Table 4 shows the quantitative evaluation results of the atomic ratio by EDX. The results in Table 4 can be reference values because quantification was made including light elements.

TABLE 4

Atomic ratio (atom %)

| Point | C | N | O | Ag |
|---|---|---|---|---|
| 1 | 84.5 | 11.4 | 3.8 | 0.4 |
| 2 | 70.2 | 20.2 | 1.4 | 8.2 |

This application claims priority based on Japanese Application No. 2021-057353 filed on Mar. 30, 2021, the disclosure of which is incorporated by reference herein.

### EXPLANATION OF REFERENCES

1 Silver-containing film (before sliding process)
2 Silver-containing layer
3 Particles made of non-conductive organic compound
4 Carbon-containing reactive layer
5 Os protective film
6 C protective film 5
11 Silver-containing film (after sliding process)
11A Slid portion
21 Silver-containing film (before sliding process)
31 Silver-containing film (after sliding process)
31A Slid portion
41 Silver-containing film (before sliding process)
51 Silver-containing film (after sliding process)
51A Slid portion

1. A silver-containing film comprising:
a silver-containing layer containing silver in an amount of 50 mass % or more, and
particles made of a non-conductive organic compound and being in contact with the silver-containing layer,
wherein a carbon-containing reactive layer can be formed on the silver-containing layer.

2. The silver-containing film according to claim 1, wherein the non-conductive organic compound contains any one or more selected from a list consisting of a carbonyl group (—C(═O)—), an amino group (—NR¹R² wherein R¹ and R² are hydrogen or a hydrocarbon group, and R¹ and R² may be identical or different) and a hydroxy group (—OH), in a unit molecular structure.

3. The silver-containing film according to claim 1 or 2, comprising the carbon-containing reactive layer on the silver-containing layer.

4. A method for producing the silver-containing film according to claim 3, comprising a step of subjecting the silver-containing film according to claim 1 or 2 to a sliding process.
